(19) United States
(12) Patent Application Publication
(10) Pub. No.: US 2003/0106651 A1
(43) Pub. Date: Jun. 12, 2003

(54) Shade incorporating spacer cords adhered to the shade with an adhesive

(76) Inventor: Wendell B. Colson, Weston, MA (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/305,972

(22) Filed: Nov. 29, 2002

Related U.S. Application Data
(60) Provisional application No. 60/338,934, filed on Dec. 7, 2001.

(51) Int. Cl. E06B 3/48

(52) U.S. Cl. 160/84.04

(57) ABSTRACT

Pleated shade coverings for architectural openings, including roman shades and pleated blinds, are described, which incorporate spacers cords that are adhesively bonded to the shade material at spaced locations, preferably on the backside of a shade material to control the configuration of the shade material in the extended position.

### CROSS REFERENCE TO RELATED APPLICATIONS

This application is related and claims priority to U.S. provisional application Serial No. 60/338,934, filed Dec. 7, 2001. The related application is hereby incorporated by reference as though fully set forth herein.

### BACKGROUND OF THE INVENTION

This invention relates generally to coverings for architectural openings, such as pleated shades, and more specifically to the use of a spacer cord that is adhered to the shade at various locations using adhesive beads.

### DESCRIPTION OF RELATED ART

Pleated blinds and Roman shades are popular coverings for use on architectural openings, such as windows. Pleated blinds as used herein refer to any number of coverings made from a variety of materials that when in a retracted position form a plurality of folds along predetermined pleats (or creases), wherein the material of each fold over onto itself about the pleat. Preferably, when extended to cover an opening, the pleats will be at least partially maintained, wherein the two opposing sections of material form an acute angle with each other. Roman shades as used herein refer to any number of coverings that when in a retracted position form a stack of substantially parallel generally horizontally-extending looped folds of shade material.

Prior art FIGS. 1 and 2 illustrate one style of pleated blind assembly 10 in both the extended and retracted positions respectively. When extended as shown in FIG. 1, a piece of pleated shade material 12 hangs between a headrail 14 and a footrail 16. A lift cord 18 is typically secured to the footrail 16 and threaded through the pleated shade material 12 into the headrail 14, and is utilized for retracting and extending the blind assembly. Since the top portion of the shade material 12 carries the weight of the shade material 12 disposed beneath it, the pleats of the top portion may be pulled open a greater amount than the pleats in lower portions. If the weight of the lower portions are heavy enough, the shade material in the top portion can be pulled taught, causing the pleat to completely disappear. The result can be a pleated shade that has unevenly sized pleats from the top to the bottom making it aesthetically displeasing.

To combat this problem, it is known to place one or more middlerails 20 between the headrail 14 and the footrail 16, and to suspend each middlerail to the headrail or another middlerail located directly above using spacer cords 22 (or straps), wherein the pleated material 12 above the middlerail does not carry the weight of the pleated material 12 below. The result is a more uniform pleated appearance when the pleated blind is in the extended position. It is also known to use the spacer cords 22 to provide support to each pleat through loops 24 or hooks (not shown) that extend from the spacer cords and are looped around the lift cords 18, wherein the maximum spacing between pleats when the blind is extended is set by the distance between adjacent loops or hooks on the spacer cord. Additionally, by connecting the spacer cords 22 to the lift cords 18, the spacer cords are encouraged to gather neatly at the back of the pleated blind when the blind is retracted, as shown in FIG. 2, so that the spacer cords are not readily visible from the front of the pleated blind.

As can be appreciated, the necessity to form loops 24 in the spacer cords 22 and pass the lift cords 18 through the loops during fabrication of the pleated blind 10 can significantly increase both the complexity and cost of producing a pleated blind. The alternative means of using hooks passed through loops 24 in the spacer cords 22 does alleviate the need to thread the lift cords 18 through the loops 24, but an additional manufacturing step is required to attach the hooks to both the lift cord 18 and the spacer cord 22.

Prior art FIGS. 3 and 4 illustrate one style of roman shade 30. The roman shade is generally comprised of a fabric shade material 32 that has a plurality of evenly spaced horizontal ribs 34 (or rods) extending transversely across it. The shade material 32 is suspended from a headrail 36 and typically terminates at a footrail 38. A lift cord 40 is secured to the footrail 38 and extends upwardly through a ring 42 attached to each of the plurality of ribs 34 for slideable movement therein and into the headrail 36. The roman shade, as illustrated, can also include a pair of spacer cords 44 that also extend between the headrail 36 and the footrail 38, wherein the spacer cords are fixedly connected to each of the ribs by way of a staple 46, a loop in the cord (not shown), or by a knot or other enlargement (not shown) that prevents the spacer cord from passing through a ring on each rib 34.

When retracted, the shade material 32 forms a plurality of downwardly hanging looped folds, wherein the ends of each fold is defined by two vertically adjacent ribs 34 as can best be seen in FIG. 4. When in the extended position, the spacer cords 44 limit the separation of the looped folds of shade material 32 that is located between each adjacent pair of ribs 34. This separation distance is typically shorter than the vertical length of the shade material comprising a looped fold disposed between the adjacent ribs. Accordingly, the shade material between each pair of adjacent ribs weeps and billows to create an aesthetically desirable appearance.

The manner in which the spacer cords are attached to the prior art roman shade 30 can significantly increase fabrication complexity, resulting in higher manufacturing costs. For instance, in one variation wherein a staple is utilized to secure the spacer cords to the rib, the rib must be large enough and made of a suitable material to receive the staple. In another variation, the lift cords are passed through loops formed in the spacer cords in a manner similar to the one described above regarding the pleated blind 10, thereby limiting the downward movement of a rib 34 when the spacer cord loops interact with the rings 42 on the ribs. This variation requires the use of looped spacer cords coupled with the additional fabrication step of threading the lift cords through at least one loop in each rib.

### BRIEF SUMMARY OF THE INVENTION

Pleated shade coverings for architectural openings, including, but not limited to, roman shades and pleated blinds, are described, which incorporate spacers cords that are adhesively bonded to the shade material at spaced locations, preferably on the backside of a shade material to control the configuration of the shade material in the extended position.

Other aspects, features and details of the present invention will be more completely understood by reference to the following detailed description of a preferred embodiment,

### BRIEF DESCRIPTION OF THE DRAWINGS

FIG. 1 rear isometric view of a prior art pleated blind in an extended position.

FIG. 2 is a rear isometric view of a prior art pleated blind in a retracted position.

FIG. 3 is a rear isometric view of a prior art roman shade in a extended position.

FIG. 4 is a front isometric view of a prior art roman shade in a retracted position.

FIG. 5 is a rear isometric view of a pleated blind according to one embodiment of the present invention

FIG. 6 is a partial rear isometric view of a vertical pleated blind according to one embodiment of the present invention.

FIG. 7 is a rear isometric view of a roman shade according to one embodiment of the present invention

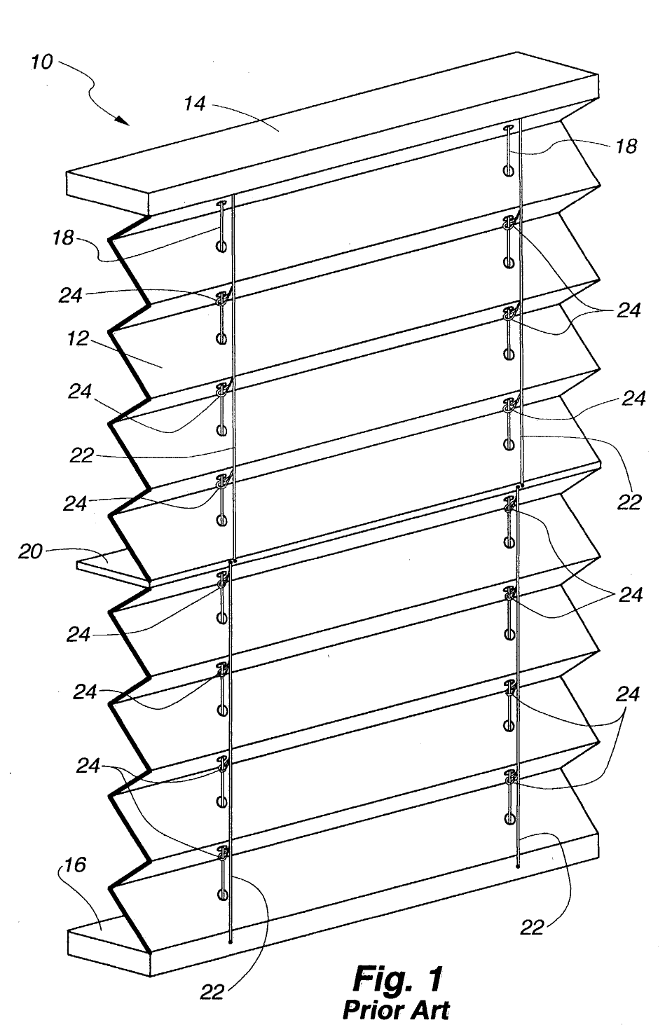

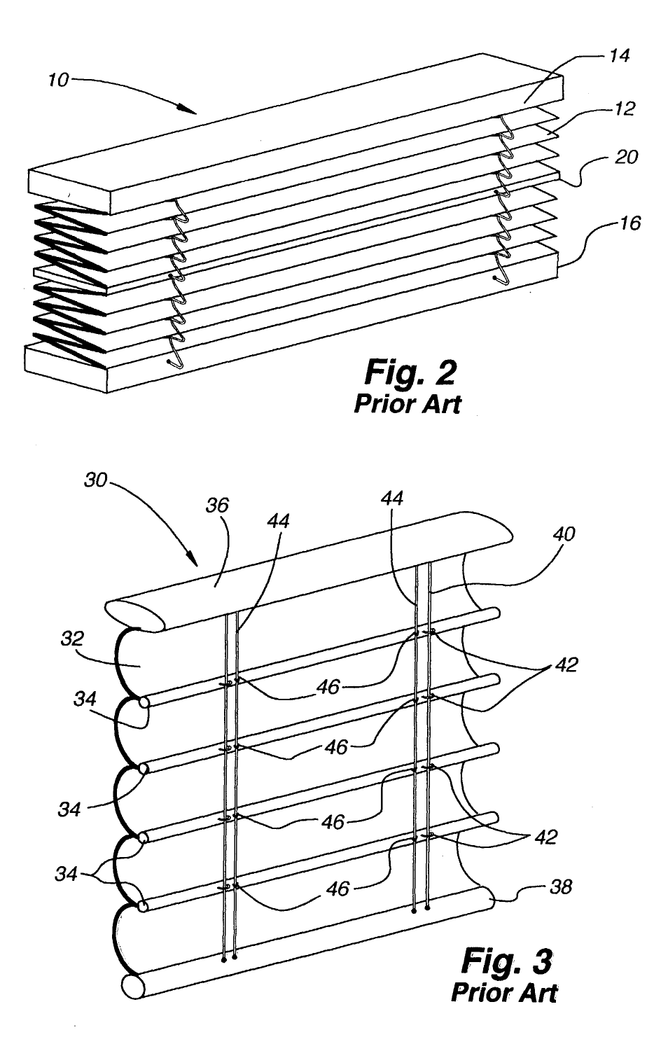

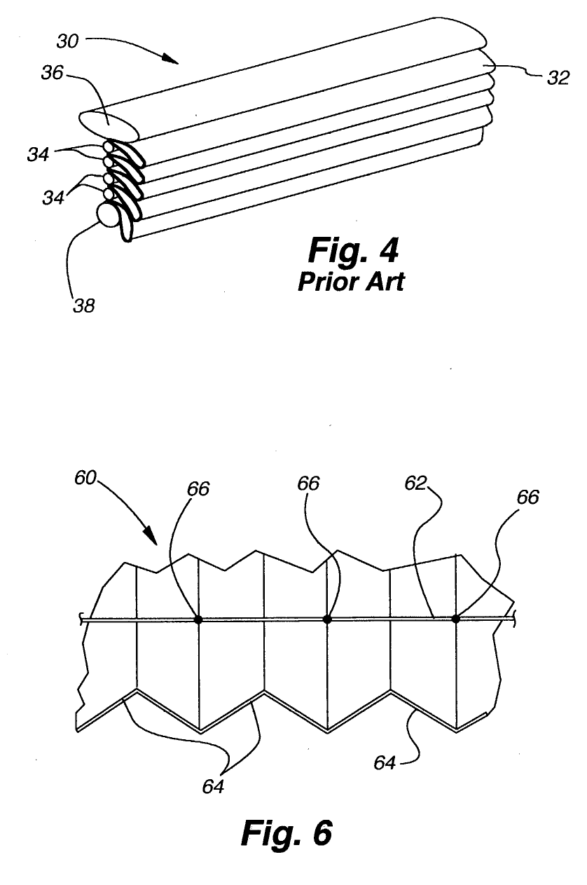

### DETAILED DESCRIPTION OF THE INVENTION

A pleated blind and a roman shade for covering an architectural opening, such as a window, are described. One or more spacer cords are adhesively bonded to each fold of the shade material, thereby limiting the maximum extension of the folded sections. The use of adhesively bonded spacer cords reduces the number and cost of manufacturing operations required to produce a pleated blind or roman shade: loops do not need to be formed in the spacer cord, nor does the lift cord need to be threaded through the loops. On roman shades in particular, the step of stapling the spacer cords to the ribs is eliminated as is the need to specify a rib made of a material that can receive a staple. Any problems that might occur due to slippage of the spacer cord in the staple as the staple works itself loose are also eliminated. Overall, the use of adhesive beads to bond the spacer cords to the pleated sections of pleated blinds and looped folds of roman shades increases the reliability of the coverings and decreases the cost to fabricate the coverings.

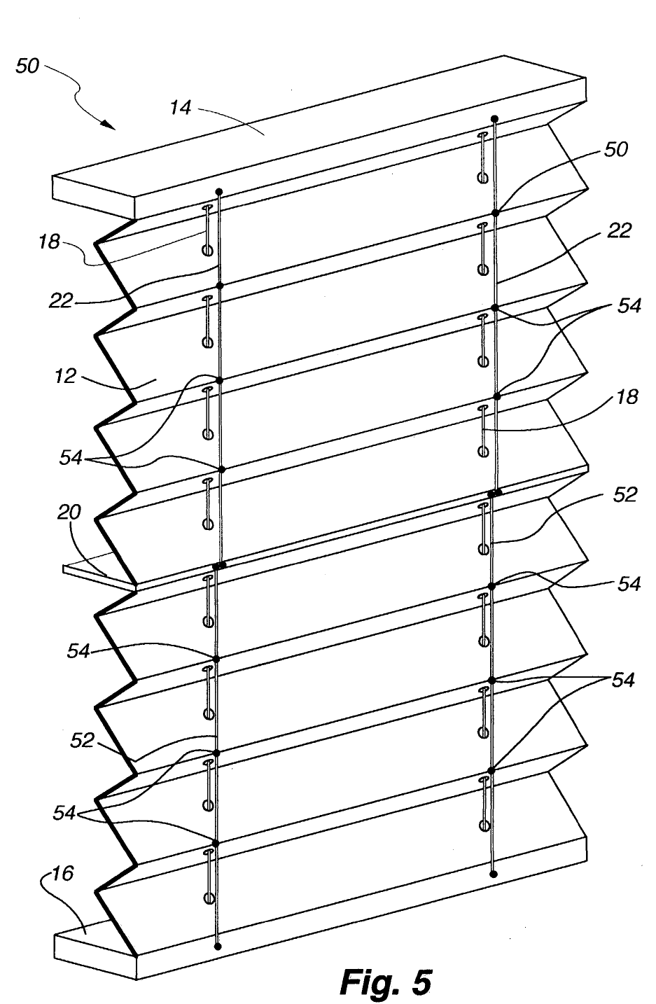

FIG. 5 is an illustration of a pleated blind 50 according to one embodiment of the present invention. The pleated blind includes a headrail 14 and a footrail 16 disposed below and connected to the headrail by two or more lift cords 18. The lift cords extend into the headrail and through a lock mechanism (not shown), whereby the lift cords can be used to raise and lower the footrail in a conventional manner.

One or more continuous sections of pleated shade material 12 extend between the headrail 14 and the footrail 16 with the lift cords typically passing through holes in the shade material. The pleated shade material 12 is typically comprised of an at least semi-rigid or rigidified material that does not noticeably sag along its horizontal span as illustrated in FIG. 5. The semi-rigid or rigid material can be comprised of a resin treated fabric, wood, plastic, or metal. Alternatively, the shade material can be comprised of individual rigid slats that are joined to each other along their longitudinal edges by way of flexible plastic or fabric hinges. In alternative embodiments, the shade material can also be comprised of a drapeable material that sags along its horizontal length as may be desired in certain applications.

The pleated blind 50 often includes one or more middlerails 20, which are horizontally disposed between sections of shade material 12. The middlerails are typically rigid and are connected to the headrail or a middlerail located directly above by one or more spacer cords 52. The middlerail 20 acts to support a lower section of pleated shade material 12 that hangs from it, isolating an upper section above it from the weight of the lower pleated section(s) that would otherwise act to pull open the pleated folds of the upper sections. Depending on the length of a particular pleated blind and the weight of the pleated shade material, more than one middlerail can be utilized. Other alternative embodiments may not include a middlerail.

As mentioned above one or more spacer cords 52 span the vertical distance between the headrail 14 and the middlerail 16. Additionally, the same or different spacer cords 52 span the vertical distance between the middlerail 20 and the footrail 16. At their ends, the spacer cords are fixedly attached by any appropriate means including adhesive bonding to their associated headrail, footrail or middlerail. Generally, the spacer cords are disposed along the rear face of the pleated blinds, so they are not visible from the front face, although in alternative embodiments the spacer cords can be located in any one of a variety of locations including the front face of the pleated blinds and the center of the pleated blinds, wherein they pass through holes provided in the pleated shade material 12.

To further support each individual pleated fold of a section of the pleated shade material and to ensure that each pleated fold opens only a predetermined maximum amount, each spacer cord is adhesively bonded to each pleated fold. In the preferred embodiment, as shown, the spacer cords 52 are attached by an adhesive bead 54 to the rearwardly facing crease of each pleated fold. Accordingly, when the pleated blind is extended, each pleated fold can open no more than the distance between the adhesive beads 54 on the spacer cords attached to two adjacent rearwardly facing creases. In alternative embodiments, the spacer cords can be adhesively bonded to any suitable location on each pleated fold. For instance, when the spacer cord is located at the center of the pleated blind and passes through holes or openings in the pleated shade material, the spacer cord can be adhesively bonded to the pleated fold at each opening.

Any suitable adhesive material can be used to form the adhesive bead 54 provided it has sufficient physical and shear strength to support the weight of the pleated folds in a section of pleated shade material disposed below the bead. In the preferred embodiment, a hot melt thermoplastic adhesive is preferred, since it lends itself to the automated application of the adhesive beads 54. In alternative embodiments any number of thermoset adhesives can be utilized as well.

Spacer cords that are adhesively secured to the pleated folds of a pleated blind can also be utilized in a vertical pleated blind as is illustrated in FIG. 6. As is shown, a spacer cord 62 is bonded to the creases of the pleated folds 64 of the vertical pleated blind by adhesive beads 66 in much the same manner as described above for horizontal pleated blinds 50. As can be appreciated, the spacer cord(s) 62 in a vertical pleated blind do not act to transfer the weight of the pleated folds 64 to the spacer cord as in horizontal pleated blinds; however, the spacer cords do help to maintain the uniform spacing of the pleated folds when the shade is fully extended and additionally the spacer cords help to maintain the creases of the pleated folds (especially when more drapeable fabrics are used for the shade material).

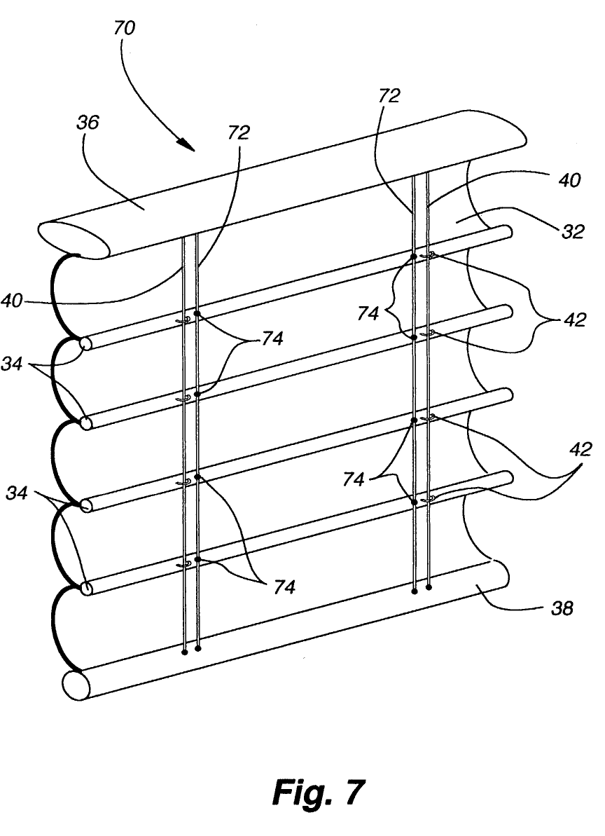

FIG. 7 is an illustration of a roman shade according to one embodiment of the present invention. The roman shade 70 comprises a headrail 36 to which a shade material 32 is attached that hangs downwardly from the headrail. A footrail 38 is typically attached to the bottom horizontal edge of the shade material.

The shade material 32 is typically a drapeable fabric, although other types of drapeable materials can be used, such as plastic films. A plurality of evenly spaced rigid or semirigid ribs 34 typically extend across the shade material from one vertical edge to the other. The ribs 34 can be made of any suitable material such as but not limited to wood, plastic, metal and composite. The ribs 34 can have any suitable shape and can be attached to the shade material 32 in any number of ways as would be obvious to one of ordinary skill in the art. Generally, the ribs are attached to the rear face of the shade so they are not visible from the front side. A pair of vertical lift cords 40 configured to facilitate the raising and lowering of the shade are fixedly attached to the footrail 38 at one end and threaded through a ring 42 on each of the ribs and subsequently into the headrail where a lock mechanism (not shown) is typically provided to hold the shade in a desired position. The rings, which can be molded into the ribs in certain embodiments are sized to receive a lift cord for slideable vertical movement therethrough. As the shade 70 is being retracted from an extended position to a retracted position by pulling the footrail upwardly via the lift cords 40, a first looped fold of shade fabric is formed between the footrail 38 and the lowest rib 34. When the footrail comes into contact with the lowest rib, the lowest rib is pushed upwardly by the footrail and a second looped fold of shade fabric is formed between the lowest rib and an adjacent rib that is directly above the lowest rib. The looped folds of shade material continue to form until the top rib is brought into contact with the headrail 36 and the roman shade 70 is in its fully retracted position.

A pair of vertically extending spacer cords 72 is provided that are fixedly attached to the headrail 36 at one end and the footrail 38 at the other end as is shown in FIG. 6. The spacer cords 72 are adhesively affixed to each of the ribs by an adhesive bead 74, wherein the distance between vertically adjacent adhesive beads on a spacer cord determines the maximum extension distance between adjacent ribs. When the length of the shade material between the adjacent ribs is greater than the maximum extension distance, the shade material is encouraged into a aesthetically desirable weeping or billowing configuration as illustrated.

It is appreciated that numerous alternative embodiment roman-style shades are contemplated that utilize a spacer cord that is attached to the shade material by way of an adhesive material. For instance, in certain alternative embodiments the ribs can be fabricated from a more flexible material that is designed to flex causing the shade material to droop in between the spacer cords. In other embodiments the ribs may be eliminated altogether with the spacer cords adhesively attached directly to the fabric of the shade material in such a manner as to facilitate the forming of ornate aesthetically pleasing configurations in both the extended and retracted positions.

Although the present invention has been described with a certain degree of particularity, it is understood that the present disclosure has been made by way of example, and changes in detail or structure may be made without departing from the spirit of the invention as defined in the appended claims.

What is claimed is:

1. A covering for an architectural opening comprising:
a substantially horizontally-extending headrail, the headrail being adapted for attachment to a support surface;
a substantially horizontally-extending footrail, the footrail being vertically disposed beneath the headrail;
at least one substantially horizontally-extending middlerail, the middlerail being disposed vertically in between the headrail and the footrail;
a first horizontally-pleated shade section, the first horizontally-pleated shade section continuously extending between the headrail and the middlerail and being coupled to the headrail at a top end and to the middlerail at a bottom end;
a second horizontally-pleated shade section, the second horizontally-pleated shade section continuously extending between the headrail and the middlerail and being coupled to the middlerail at a top end and to the footrail at a bottom end;
at least one substantially vertically-orientated spacer cord, the spacer cord being fixedly attached to the headrail and to one or both of the middlerail and the footrail, the spacer cord being adhesively bonded to the first horizontally-pleated shade section at a plurality of vertically-spaced locations.

2. The covering of claim 1, wherein the at least one spacer cord extends from the head rail to the footrail and is affixed to the middle rail and the footrail.

3. The covering of claim 1, wherein the at least one spacer cord includes at least two spacer cords.

4. The covering of claim 3, wherein one of the at least two spacer cords extends from the headrail to the footrail and the other of the at least two spacer cords extends from the middlerail to the footrail.

5. The covering of claim 1, wherein the first and second shade sections form a continuous shade.

6. The covering of claim 1, wherein the first and second shade sections are distinct from each other.

7. The covering of claim 1, wherein the first shade section comprises a rigid or semi-rigid material.

8. The covering of claim 1, wherein the at least one spacer cord is adhesively bonded to the first shade section with a hot melt thermoplastic adhesive.

9. The covering of claim 1, wherein the at least one spacer cord is attached to the rear face of the first shade section and is not substantially visible from a front face of the first shade section.

10. The covering of claim 9, wherein the at least one spacer cord is bonded to the rear face of the first shade section at creases of the pleats of the first shade section. 11:
a covering for an architectural opening comprising:
a substantially horizontally-extending headrail, the headrail being adapted for attachment to a support surface;
a substantially horizontally-extending footrail, the footrail being vertically disposed beneath the headrail;
a continuous roman shade, the continuous roman shade coupled to the headrail at a top end and to the footrail at a bottom end;
a substantially vertically-orientated spacer cord, the spacer cord being fixedly attached to the headrail at a top end and to the footrail at a bottom end, the spacer cord being adhesively bonded to the continuous roman shade at a plurality of vertically-spaced locations.

12. The covering of claim 11, wherein the roman shade includes a plurality of spaced substantially horizontally-extending ribs.

13. The covering of claim 12, wherein the ribs are comprised of a substantially rigid or semi-rigid material.

14. The covering of claim 13, wherein the ribs are comprised of a generally flexible material.

15. The covering of claim 12, wherein the spacer cord is bonded to the plurality of ribs.

16. The covering of claim 12, wherein the plurality of ribs are positioned on the rear face of the roman shade and are not generally visible from the front face.

17. The covering of claim 11, wherein the spacer cord is adhesively bonded to the roman shade by a hot melt thermoplastic resin.

18. A covering for an architectural opening comprising:
a substantially horizontally-extending headrail, the headrail being adapted for attachment to a support surface;
a continuous shade having a top end and a bottom end, the continuous shade being slideably coupled with the headrail at a top end; and
a substantially horizontally-orientated spacer cord, the spacer cord being adhesively bonded to the continuous shade at a plurality of horizontally-spaced locations proximate the bottom end.

19. The covering of claim 18, wherein the shade comprises a drapeable fabric.

20. The covering of claim 18, wherein the spacer cord is adhesively bonded to rear facing creases of pleated folds in the shade.
